(19) United States
(12) Patent Application Publication
(10) Pub. No.: US 2008/0020111 A1
(43) Pub. Date: Jan. 24, 2008

(54) Bread maker and control method thereof

(75) Inventors: Jae-ryong Park, Suwon-city (KR); Yong-hyun Kwon, Suwon-city (KR); Chul Kim, Anyang-city (KR); Tae-uk Lee, Suwon-city (KR); Han-jun Sung, Suwon-city (KR); Jang-woo Lee, Suwon-city (KR); Dong-bin Lim, Suwon-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/889,320

(22) Filed: Aug. 10, 2007

Related U.S. Application Data
(62) Division of application No. 10/809,371, filed on Mar. 26, 2004, now abandoned.

(30) Foreign Application Priority Data
May 7, 2003 (KR) 2003-29063

(51) Int. Cl. A21D 6/00; A23L 1/48

(52) U.S. Cl. 426/416; 426/504

(57) ABSTRACT

A bread maker including a main body forming an oven compartment; upper and lower kneading drums spaced apart from each other inside the oven compartment, each kneading drum having a holding part holding opposite ends of a mixing bag filled with dough; a drum driving part rotating the kneading drums in clockwise and counterclockwise directions to knead the dough contained in the mixing bag; a cancel button for selecting cancel of bread making process; a rotation sensing part sensing rotation positions of the kneading drums; and a controller which controls the drum driving part so that the drum driving part rotates the kneading drums to remove the mixing bag from the holding part of the lower kneading drums on the basis of rotation position signals of the pair of kneading drums detected by the rotation sensing part and canceling information of the bread making process from the cancel button. Thus, a user can easily remove the mixing bag when the bread making is canceled.

### CROSS-REFERENCE TO RELATED APPLICATIONS

This application is a divisional application of application Ser. No. 10/809,371 filed Mar. 26, 2004, and claims the benefit of Korean Application No. 2003-29063, filed May 7, 2003, in the Korean Intellectual Property Office, the disclosure of which is incorporated herein by reference.

### BACKGROUND OF THE INVENTION

1. Field of the Invention

The present invention relates to a bread maker which automatically makes bread and a control method thereof.

2. Description of the Related Art

Generally, making bread is so complicated that it is difficult for average persons to make good bread at home by hand. This is because the process of making bread includes multiple operations of mixing ingredients such as flour, sugar, yeast, etc., to form a dough; kneading the dough; leavening the dough; baking the dough; and so on.

Therefore, various bread makers have been developed to allow a user to easily make bread by automatically performing the foregoing multiple operations to provide finished bread to the user.

For example, a bread maker disclosed in Korean Patent Publication No. 1991-10203 includes a pair of parallel kneading drums at upper and lower parts of an oven compartment that reverse rotary direction periodically, a baking tray between the pair of kneading drums, a heater to heat the inside of the oven compartment, a bar code scanner, etc.

In the bread maker according to Korean Patent Publication No. 1991-10203, upper and lower ends of a mixing bag filled with flour, water, etc., are attached to the upper and lower kneading drums, and then the mixing bag is reciprocated up and down for a predetermined period of time, thereby kneading the dough in the mixing bag.

After completing the kneading of the dough, the mixing bag is automatically separated from the upper kneading drum, and is completely wound on the lower kneading drum, with the dough being squeezed out of the mixing bag into the baking tray. Thereafter, the heater heats the inside of the oven compartment, thereby leavening and baking the dough over a predetermined period of time.

The process of making the bread depends on reading a bar code 9 that is printed on the mixing bag. The bar code 9 contains information on kneading time, leavening time, baking time, etc., according to a specific recipe. The bar code 9 is read by a bar code scanner and the read data are transmitted to a controller that controls the kneading drums, the heater, etc., on the basis of the read data.

However, making the bread may need to be canceled during the bread making process owing to the user abruptly leaving the premises.

In this case, according to a conventional bread maker, if the bread making is canceled by a user's selection during the bread making process, in particular, during a kneading process, the bread making information of a controller is initialized and parts of the conventional bread maker such as a kneading drum are stopped at a time when the bread making is canceled. Thus, it is difficult to remove the mixing bag wound on the kneading drum.

For example, when the bread making process is canceled during the kneading process, a user has to rotate upper and lower kneading drums clockwise or counterclockwise with his/her own hands until the mixing bag is removed. When the bread making process is canceled after the kneading process is completed, a user has to pull the mixing bag and rotate the lower kneading drum to remove the mixing bag wound on the lower kneading drum.

### SUMMARY OF THE INVENTION

An aspect of the present invention provided a bread maker and a control method thereof, in which a mixing bag is easily removed when bread making is canceled.

According to the present invention, a bread maker comprises a main body forming an oven compartment; upper and lower kneading drums spaced apart from each other inside the oven compartment, each kneading drum having a holding part holding opposite ends 8 of a mixing bag filled with dough; a drum driving part rotating the kneading drums in clockwise and counterclockwise directions to knead the dough contained in the mixing bag; a cancel button to select cancellation of a bread making process; a rotation sensing part sensing rotation positions of the kneading drums; and a controller which controls the drum driving part so that the drum driving part rotates the kneading drums to remove the mixing bag from the holding part of the lower kneading drum on the basis of rotation position signals of the pair of kneading drums detected by the rotation sensing part and canceling information of the bread making process from the cancel button.

In an aspect of the invention, the controller controls number of rotation times of the kneading drums on the basis of the rotation position sensed by the rotation sensing part.

In an aspect of the invention, the controller controls the drum driving part so that the upper kneading drum is rotated opposite to a wound direction of the mixing bag on the upper kneading drum after the mixing bag is removed from the lower kneading drum.

In an aspect of the invention, the controller controls the number of rotation times of the kneading drums so that the upper kneading drum is rotated to a position in which the mixing bag was first held.

In an aspect of the invention, the bread maker further comprises a bar code scanner for reading a bar code 9 which is stored with bread making information such as a kneading time, a baking time and so on, and attached on the mixing bag, wherein the controller removes the bread making information which is read by the bar code scanner to be stored in a memory from the memory.

According to the present invention, a method of controlling a bread maker having an oven compartment, a pair of kneading drums spaced apart from each other inside the oven compartment with each kneading drum having a holding part holding opposite ends of a mixing bag filled with dough, and a drum driving part rotating the kneading drums to knead the dough contained in the mixing bag, comprises detecting rotation positions of the kneading drums when the bread making process is canceled; rotating the kneading drums so that the mixing bag is removed from the holding part of the lower kneading drum on the basis of the detected rotation positions of the kneading drums and the canceling of the bread making process.

In an aspect of the invention, the method further comprises rotating the upper kneading drum opposite to a wound direction of the mixing bag on the upper kneading drum after the mixing bag is removed from the lower kneading drum.

In an aspect of the invention, the rotating the upper kneading drum comprises controlling number of rotation times of the kneading drums so that the upper kneading drum is rotated to a position in which the mixing bag was first held.

In an aspect of the invention, the method further comprises providing a bar code scanner for reading a bar code 9 which is stored with bread making information such as a kneading time, a baking time and so on and attached on the mixing bag, and removing the bread making information, which is read by the bar code scanner and stored in a memory, from the memory.

Additional and/or other aspects and advantages of the invention will be set forth in part in the description that follows, and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view of a bread maker according to an embodiment of the present invention;

FIG. 2 is a cut-away perspective view of an electric component compartment of the bread maker in FIG. 1;

FIG. 3 is a control block of the bread maker in FIG. 1; and

FIG. 4 is a control flowchart of the bread maker according to another embodiment of the present invention;

FIG. 5 illustrates a mixing bag filled with ingredients according to the present invention.

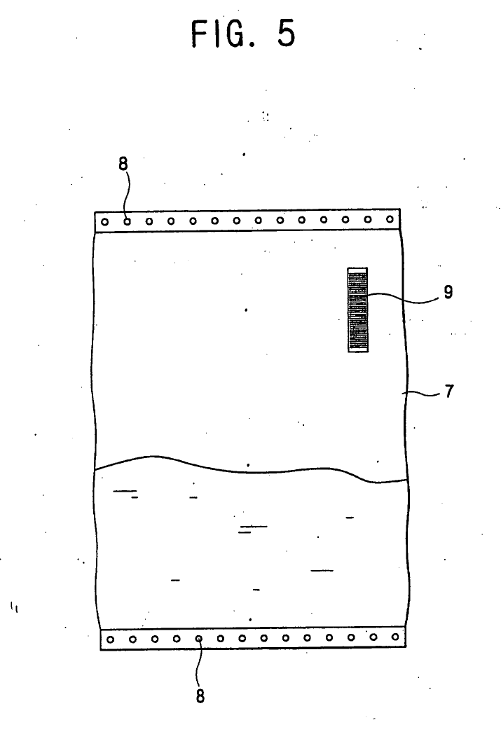

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

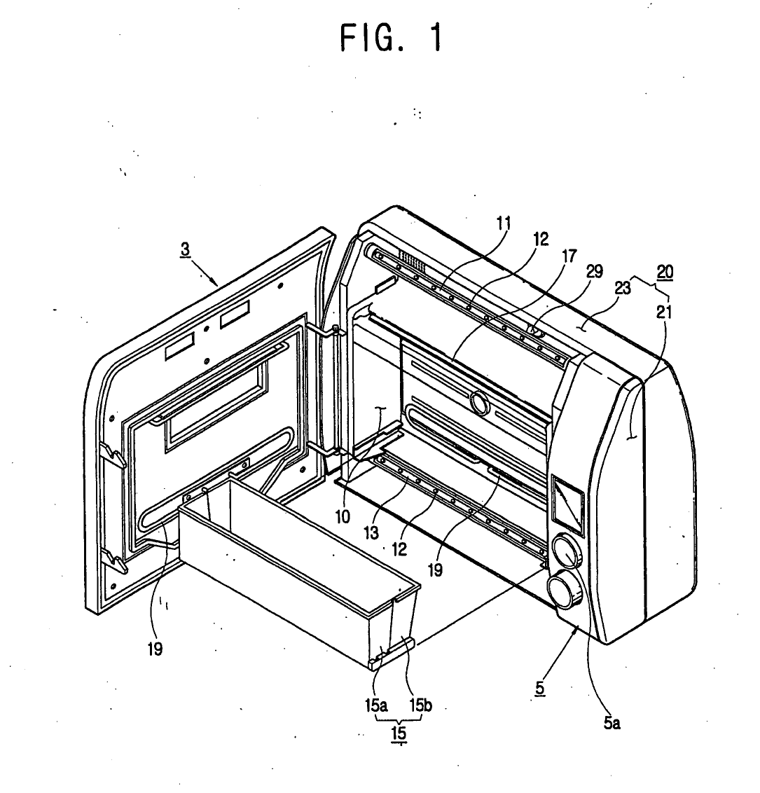

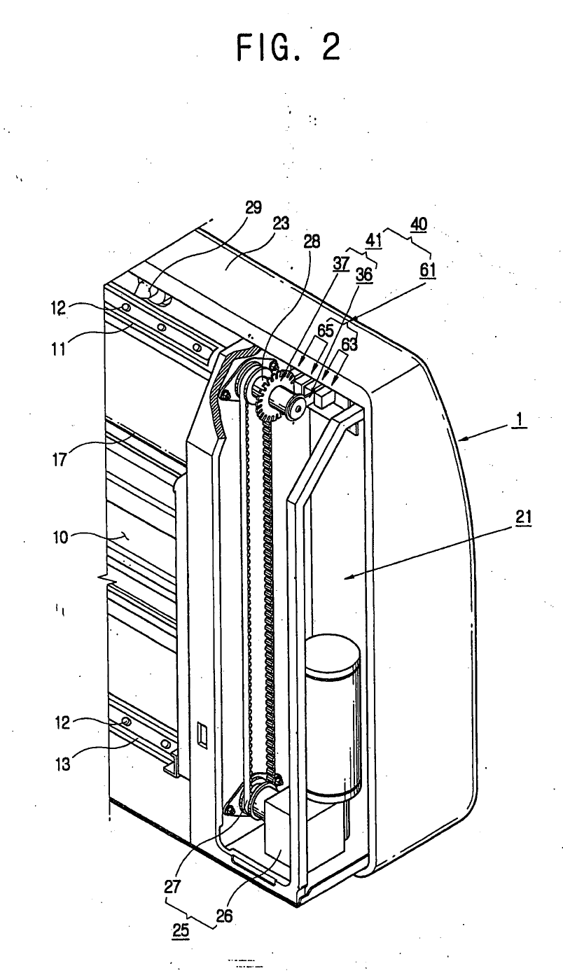

FIG. 1 is a perspective view of a bread maker according to an embodiment of the present invention, and FIG. 2 is a cut-away perspective view of an electric component compartment of the bread maker in FIG. 1. As shown in FIGS. 1 and 2, the bread maker, according to an embodiment of the present invention, includes a main body 1 divided into an oven compartment 10 and an electric component compartment 20, a door 3 in the front of the main body 1 to open and close a front opening of the oven compartment 10, and a control panel 5 in the front of the main body 1 to allow a user to control the bread maker and to know the status of the bread maker.

A cancel button 5a is included in the control panel 5 which a user may engage to cancel bread making. When the user presses the cancel button 5a, the cancel button 5a generates a bread-making cancel signal.

Inside the oven compartment 10, upper and lower kneading drums 11 and 13 are provided in parallel and reciprocally rotate, onto which opposite ends 8 of a mixing bag 7 filled with raw materials (ingredients) to make bread are attached and wound. In a lower part of the oven compartment 10, a baking tray 15, which contains the dough for baking, is provided between the upper and lower kneading drums 11 and 13.

The baking tray 15 includes first and second trays 15a and 15b having “L”-shaped cross sections symmetrical to one another. The first and second trays 15a and 15b combine to form a box having a top opening. In an upper part of the oven compartment 10, a pair of squeezing members 17 between the upper kneading drum 11 and the baking tray 15 prevents the dough kneaded in the mixing bag 7 from moving beyond the baking tray 15 toward the upper kneading drum 11.

At upper and lower parts of the inside walls of the oven compartment 10 and the door 3, heaters 19 to heat the inside of the oven compartment 10 are provided.

The electric component compartment 20 includes a first component compartment 21 beside the oven compartment 10 and a second component compartment 23 behind the oven compartment 10. Inside the first component compartment 21 a drum driving part 25 to rotate the upper and lower kneading drums 11 and 13 in clockwise and counterclockwise directions. Inside the second component compartment 23, a bar code scanner 29 that reads a bar code 9 printed on, or applied to, the mixing bag 7, which is wound on the upper and lower kneading drums 11 and 13, is provided.

The mixing bag 7 contains raw materials for the bread making, for example, wheat flour, sugar, and so on, in a flexible and tightly sealed bag thereof. The bar code 9, which contains information on kneading time, leavening time, leavening temperature, baking time, baking temperature, evaporation, etc., is attached to one side of the mixing bag 7.

The drum driving part 25 includes a motor 26 rotating the lower kneading drum 13, and a belt 27 transmitting a rotary movement of the lower kneading drum 13 to a rotation shaft 28 of the upper kneading drum 11. The bar code scanner 29 is able to move near to, and distantly from, an outer circumference of the upper kneading drum 11.

The bread maker according to an embodiment of the present invention comprises a rotation sensing part 40 detecting one or more rotation positions of at least one of a pair of kneading drums 11 and 13, and a controller 70 (to be described later) which controls the drum driving part 25 so that the mixing bag 7 is removed from a holding part of the lower kneading drum 13 on the basis of rotation position signals of the pair of kneading drums 11 and 13, detected by the rotation sensing part 40, as well as cancel information of the bread making process generated through the cancel button 5a.

The rotation sensing part 40 includes a disk part 41 attached to the rotation shaft 28 of the upper kneading drum 11, and a rotation sensor 61 placed near the disk part 41, which outputs a pulse signal by sensing the rotation of the disk part 41.

The disk part 41 includes a first disk 36 that allows the rotation sensor 61 to sense one revolution of the upper kneading drum 11, and a second disk 37 that allows the rotation sensor 61 to sense a rotation less than one revolution of the upper kneading drum 11.

The first and second disk 36 and 37 have a circular shape, in which the first disk 36 has one detecting projection and the second disk 37 has twenty four detecting projections respectively in circumstance thereof.

It is understood that the rotation sensing part 40 may also comprise a single rotation disc as a circular shaped member and having convex sections and concave sections in the circumference, and a rotation signal sensor having a radiating part and a signal sensing part provided in parallel with the rotation disc interposed therebetween.

The rotation sensor 61 includes a first disk sensor 63 sensing the projection of the first disk 36 and outputting one pulse signal per revolution of the upper kneading drum 11. The rotation sensor 61 also includes a second disk sensor 65 sensing the twenty-four projections of the second disk 37 and outputting twenty-four pulse signals per revolution of the upper kneading drum 11. That is, when the upper kneading drum 11 makes one revolution, the first and second disk sensors 63 and 65 output one and twenty-four pulse signals, respectively.

The pulse signals outputted from the first and second disk sensor 63 and 65 of the rotation sensor 61 are transmitted to the controller 70. The controller 70 detects the rotation position of the upper kneading drum 11 on the basis of the pulse signal outputted therefrom and controls the motor 26 of the drum driving part 25 rotating the upper and lower kneading drums 11 and 13 during kneading, to thereby accurately control a distance between upper and lower positions of the mixing bag 7.

For example, the controller 70 rotates the motor 26 clockwise to move the mixing bag 7 upwards until the controller 70 receives the pulse signal detected by the second disk sensor 65 ten times, the controller 70 receives the pulse signal detected by the first disk sensor 63 three times, and the controller 70 receives the pulse signal detected by the second disk sensor 65 ten times. The controller 70 then rotates the motor 26 counterclockwise to move the mixing bag mixing bag 7 downwards until the controller 70 receives the pulse signal detected by the second disk sensor 65 ten times, the controller 70 receives the pulse signal detected by the first disk sensor 63 three times, and the controller 70 receives the pulse signal detected by the second disk sensor 65 ten times. In such a period, the controller 70 rotates the motor 26 clockwise and counterclockwise during a predetermined time set up in a bar code 9 to move the mixing bag 7 upwards and downwards, thereby controlling raw materials (ingredients) in the mixing bag 7 to be kneaded.

It is understood that there are many known ways to sense entire and/or partial rotations of shafts such as the rotation shafts discussed above. Thus, the above description is not intended to limit the invention disclosed herein.

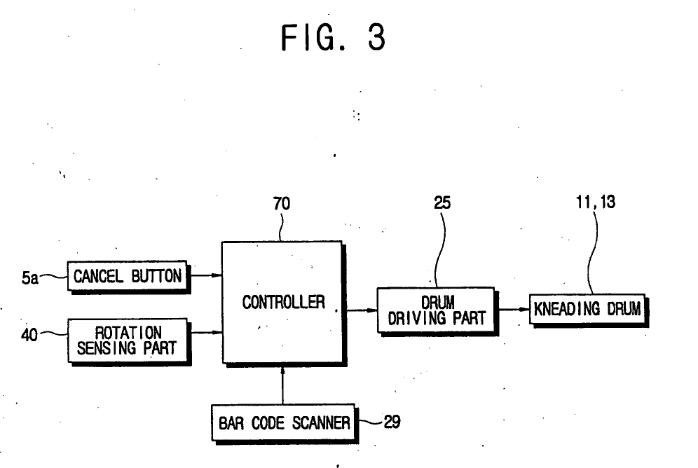

FIG. 3 is a block diagram of the bread maker in FIG. 1 according to an embodiment of the invention. As shown in FIG. 3, the bread maker according to the embodiment of the present invention comprises a cancel button 5a through which a user cancels the bread making process, a rotation sensing part 40 detecting one or more rotation positions of at least one of a pair of kneading drums 11 and 13, and the controller 70 to control the rotation positions of the pair of kneading drums 11 and 13 on the basis of the rotation position thereof detected by the rotation sensing part 40 and cancel signal of the bread making process generated through the cancel button 5a.

According to the present invention, the controller 70 removes bread-making information, which is previously set up therein on the basis of bar code information read by the bar code scanner 29, from a memory when a cancel signal is generated during bread making, and controls the motor 26 to rotate the upper and lower kneading drums 11 and 13 so that the mixing bag 7 may be removed from the holding part of the lower kneading drum 13 on the basis of a rotation position detected by the rotation sensing part 40.

The controller 70 may control the motor 26 to rotate the upper and lower kneading drums 11 and 13 in a reverse direction relative to a rotation direction described above so that the mixing bag 7 can be unwound from the upper kneading drum 11.

The controller 70 controls a rotation angle and a number of rotation times of the upper and lower kneading drums 11 and 13 through the first and the second disk sensors 63 and 65.

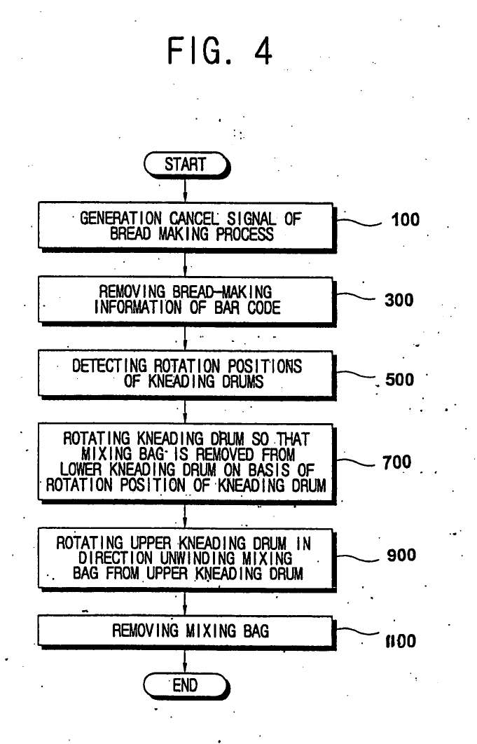

FIG. 4 is a control flowchart of the bread maker according to the embodiment of the present invention. As shown in FIG. 4, if a user selects cancel of the bread making to generate a cancel signal of the bread making (100), the controller 70 receives the cancel signal of the bread making, and then removes the bread-making information stored therein on the basis of the bar code 9 attached on the mixing bag 7 from the memory thereof and ends the bread making accordingly (300). The controller 70 rotates the upper and lower kneading drums 11 and 13 on the basis of the rotation position of the upper and lower kneading drums 11 and 13, which is detected when a user cancels the bread making by using the cancel button 5a (500), so that the mixing bag 7 is removed from the lower kneading drum 13 (700).

For example, when the bread making is canceled in a state in which the mixing bag 7 is wound in the upper kneading drum 11 by three turns, that is, in a state in which the mixing bag 7 is wound to the utmost in the upper kneading drum 11 during a kneading process, the mixing bag 7 is controlled to be removed from the lower kneading drum 13 by rotating the upper kneading drum 11 halfway through 1 more turn in a winding direction of the mixing bag 7 on the upper kneading drum 11. This winding may be performed without respect to whether the mixing bag 7 is wound in the lower kneading drum 13.

Also, when the bread making is canceled during the kneading process, the kneading drums 11 and 13 rotate to a state in which the mixing bag 7 is wound into the upper kneading drum 11 to the utmost during the kneading process on the basis of the detected rotation position, and then the mixing bag 7 is controlled to be removed from the lower kneading drum 13 by rotating the upper kneading drum 11 halfway through 1 more turn in a winding direction of the mixing bag 7 on the upper kneading drum 11.

Further, once the kneading process is completed, a vacant mixing bag 7 is removed from the upper mixing drum 11 and completely wound on the lower kneading drum 13, the lower kneading drum 13 is rotated and accordingly the vacant mixing bag 7 is unwound to be removed from the lower kneading drum 13.

When the bread making is canceled while the mixing bag 7 is wound on the lower kneading drum 13 as the completely mixed raw material is discharged to the baking tray 15, the mixing bag 7 may not unwind from the lower kneading drum 13 until the mixing bag 7 is completely wound in advance on the lower kneading drum 13.

When the mixing bag 7 is removed from the lower kneading drum 13, the upper kneading drum 11 rotates in an unwinding direction, thereby unwinding the mixing bag 7 from the upper kneading drum 11 (900).

Herein, the upper kneading drum 11 is controlled to rotate to a position in which the mixing bag 7 is held first, so that a user may easily remove the mixing bag 7 from the upper kneading drum 11 (1100).

According to the above embodiment of the present invention, the mixing process in which the kneading drums and the rotation sensing part operate is described, but the bread making operations (for example, kneading, leavening, baking, etc.), which are in progress and are stored in the controller may be confirmed.

With the above configuration, when the bread making is canceled, the mixing bag 7 is removed from the lower kneading drum 11 and then the upper kneading drum 13 rotates in a direction unwinding the mixing bag 7, so that a user can easily remove the mixing bag 7 therefrom.

As described above, according to the present invention, provided is a bread maker, in which a user can easily remove the mixing bag 7 when the bread making process is canceled.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A method of controlling a bread maker having an oven compartment, upper and lower kneading drums spaced apart from each other inside the oven compartment with each kneading drum having a holding part holding opposite ends of a mixing bag filled with dough, and a drum driving part rotating the kneading drums to knead the dough contained in the mixing bag, the method comprising:
detecting rotation positions of the kneading drums when the bread making process is canceled;
rotating the kneading drums so that the mixing bag is removed from the holding part of the lower kneading drum based on the detected rotation positions of the kneading drums and the cancellation of the bread making process.

2. The method according to claim 1, further comprising rotating the upper kneading drum opposite to a wound direction of the mixing bag on the upper kneading drum after the mixing bag is removed from the lower kneading drum.

3. The method according to claim 2, wherein the rotating the upper kneading drum comprises controlling number of rotation times of the kneading drums so that the upper kneading drum is rotated to a position in which the mixing bag was first held.

4. The method according to claim 1, further comprising:
providing a bar code scanner for reading a bar code which is stored with bread making information and which is attached on the mixing bag; and
storing the bread making information, which is read by the bar code scanner, in a memory.

5. A method of controlling the removal of a mixing bag filled with ingredients to make bread from a bread maker having an upper and lower kneading drum on which the mixing bag is wound, following a cancellation of a bread making process, comprising:
generating a cancel signal of the bread making process;
detecting rotating positions of the upper and lower kneading drums;
rotating the upper kneading drum in a first direction such that the mixing bag is removed from the lower kneading drum based upon the detected rotating positions; and
rotating the upper kneading drum in a second direction; and
removing the mixing bag from the bread maker.
